(19) United States
(12) Patent Application Publication
(10) Pub. No.: US 2010/0243732 A1
(43) Pub. Date: Sep. 30, 2010

(54) AUDIO/ACOUSTICALLY COUPLED CARD READER

(76) Inventor: GEORGE WALLNER, MIAMI BEACH, FL (US)

Correspondence Address: AKC PATENTS, 215 GROVE ST., NEWTON, MA, 02466, US

(21) Appl. No.: 12/727,448

(22) Filed: Mar. 19, 2010

Related U.S. Application Data
(60) Provisional application No. 61/163,296, filed on Mar. 25, 2009.

(51) Int. Cl. G06K 5/00; H04M 3/42

(52) U.S. Cl. 235/380; 455/414.1

(57) ABSTRACT

A system for performing mobile payment transactions includes an audio/acoustically coupled card reader, a mobile communication device, an interface server and a payment card processor. The audio/acoustically coupled card reader includes means for reading payment card data from a payment card, means for generating a stream of audio/acoustical signals comprising the payment card data and means for transmitting the stream of audio/acoustical signals. The mobile communication device includes means for receiving the stream of audio/acoustical signals, means for generating an electrical signal comprising data contained in the stream of audio/acoustical signals and means for transmitting the electrical signal. The interface server includes means for extracting the payment card data from the electrical signal and means for transmitting the payment card data. The mobile communication device connects to the interface server device via a first network and transmits the electrical signal to the interface server. The interface server connects to the payment card processor via a second network and transmits the payment card data to the payment card processor for payment processing. The payment card processor processes payments via payment card companies.

### CROSS REFERENCE TO RELATED CO-PENDING APPLICATIONS

This application claims the benefit of U.S. provisional application Ser. No. 61/163,296 filed on Mar. 25, 2009 and entitled ACOUSTICALLY COUPLED CARD READER which is commonly assigned and the contents of which are expressly incorporated herein by reference.

### FIELD OF THE INVENTION

The present invention relates to an audio/acoustically coupled card reader and in particular to a card reader that connects to a generic telephone or cell-phone via audio/acoustical signals.

### BACKGROUND OF THE INVENTION

Credit and other payment card transactions generically fall into two categories: “Card Reader” transactions and “Manual Card Data Entry” transactions. Generally, “Card Reader” transactions are preferred to “Manual Card Data Entry” transactions. “Card Reader” transactions are more secure and attract lower merchant charges than “Manual Card Data Entry” transactions. “Card Reader” transactions are also more convenient, faster and less likely to contain errors.

Cellphones (and ordinary phones) offer a low cost means of entering and processing card payments. However, phones and cell-phones are limited by the fact that they are not equipped with card readers and thus can only process transactions in the “Manual Card Data Entry” mode. Attaching an external card reader is made difficult by the fact that cellphones do not contain a universal interface or connector that would allow an easy and convenient connection. Therefore phones and cellphones are used as card payment devices mostly in the manual key entry mode. This has limited their usefulness, as merchants prefer to avoid the higher charges and inconvenience of manual card entry. Although external card readers can be attached to certain cellphones through a wired connection (such as USB), an infrared link, or a Bluetooth RF interface, such attachments have not been proven practical for installations by users to their generic phones, as none of the above interfaces are standardized and they are not plug-and-play.

### SUMMARY OF THE INVENTION

This invention describes a card reader that connects to a phone or cellphone using audio or acoustic signals. Acoustic signals are sound pressure waves and an audio signal is a representation of a sound wave in a different form. In one example, the audio signal represents the sound wave as a voltage versus time signal. In other examples, audio signals represent sound waves through alternative mediums such as magnetic particles, when recorded onto analogue tape or as RF waves, when broadcast through radio, or as pulses of light, when transmitting through fiber optic cables. An audio signal can be manipulated, stored, transmitted and reproduced in ways that sound waves cannot. Typically microphones convert sound waves into voltage, which corresponds to an audio signal. As all phones and cellphones contain a microphone used to transmit voice, they all can pick-up and transmit acoustic signals that fall within the “voice frequency” range (approximately 200 Hz to 3.8 kHz). Furthermore, some cellphones have an input (jack) for a microphone and can receive audio signals. The audio/acoustically coupled card reader of this invention can “connect” to any phone or cellphone by using sound waves or a microphone jack as the connection medium. This can be a cost-effective and universal method of turning any cellphone into a card reader equipped payment terminal.

In general, one aspect of the invention provides a system for performing mobile payment transactions including an audio/acoustically coupled card reader, a mobile communication device, an interface server and a payment card processor. The audio/acoustically coupled card reader includes means for reading payment card data from a payment card, means for generating a stream of audio/acoustical signals comprising the payment card data and means for transmitting the stream of audio/acoustical signals. The mobile communication device includes means for receiving the stream of audio/acoustical signals, means for generating an electrical signal comprising data contained in the stream of audio/acoustical signals and means for transmitting the electrical signal. The interface server includes means for extracting the payment card data from the electrical signal and means for transmitting the payment card data. The mobile communication device connects to the interface server device via a first network and transmits the electrical signal to the interface server. The interface server connects to the payment card processor via a second network and transmits the payment card data to the payment card processor for payment processing. The payment card processor processes payments via payment card companies. The mobile communication device includes the interface server.

Implementations of this aspect of the invention include the following. The second network may be the Internet, a wireless local area network (WLAN), a personal area network (PAN) or a private communication network. The first network may be a telecommunication network or a mobile telecommunication network comprising one of a Global System for Mobile Communications (GSM), a Code Division Multiple Access (CDMA), CDMA 2000, wideband CDMA (WCDMA), or 3G. The payment card comprises a magnetic stripe for storing the payment card data and the means for reading the payment card data comprises a magnetic head. The payment card comprises a contact-type smart card and the contact-type smart card comprises an electronic circuit for storing the payment card data and the means for reading the payment card data comprises electrical contact means. The payment card comprises a contactless smart card and the contactless smart card comprises an electronic circuit for storing the payment card data and the means for reading the payment card data comprises contactless near-field electromagnetic means. The audio/acoustically coupled card reader further includes means for checking for an error in the payment card data and means for indicating absence of an error in the payment card data. The audio/acoustically coupled card reader further includes means for storing the payment card data and means for activating transmission of the stream of audio/acoustical signals. The mobile communication device further comprises a keypad for entering other transaction data. The means for extracting the payment card data from the electrical signal comprises an audio decoder. The interface server further includes a first network interface, a central processing unit, a second network interface and data storage.

In general in another aspect the invention provides a method for performing mobile payment transactions including the following. Providing an audio/acoustically coupled card reader comprising means for reading payment card data from a payment card, means for generating a stream of audio/acoustical signals comprising the payment card data and means for transmitting the stream of audio/acoustical signals. Reading payment card data from a payment card via the card reader reading means, generating a stream of audio/acoustical signals comprising the payment card data via the card reader generation means and transmitting the stream of audio/acoustical signals via the card reader transmission means. Providing a mobile communication device comprising means for receiving the stream of audio/acoustical signals, means for generating an electrical signal comprising data contained in the stream of audio/acoustical signals and means for transmitting the electrical signal. Receiving the stream of audio/acoustical signals by the mobile communication device's receiving means, generating an electrical signal comprising the payment card data contained in the stream of audio/acoustical signals by the generation means of the mobile communication device and transmitting the electrical signal by the mobile communication device's transmission means. Providing an interface server comprising means for extracting the payment card data from the electrical signal and means for transmitting the payment card data. Connecting the mobile communication device to the interface server device via a first network and transmitting the electrical signal to the interface server by the mobile communication device's transmission means. Providing a payment card processor for processing payments via payment card companies. Connecting the interface server to the payment card processor via a second network, transmitting the payment card data to the payment card processor by the interface server's transmission means and processing the payment card data by the payment card processor.

Among the advantages of this invention may be one or more of the following. This invention allows easy and instantaneous connection of a card reader to a generic telephone or cell-phone. The invention overcomes the difficulty of connecting an external device to a phone or cell-phone and it turns such a phone into an effective card payment terminal.

### BRIEF DESCRIPTION OF THE DRAWINGS

Referring to the figures, wherein like numerals represent like parts throughout the several views:

FIG. 1A depicts an overview diagram of an acoustically coupled card reader system;

FIG. 1B depicts an overview diagram of an audio coupled card reader system;

FIG. 2A and FIG. 2B depict detailed diagrams of the audio/acoustically coupled card reader; and

FIG. 3 is a block diagram of the interface server.

### DETAILED DESCRIPTION OF THE INVENTION

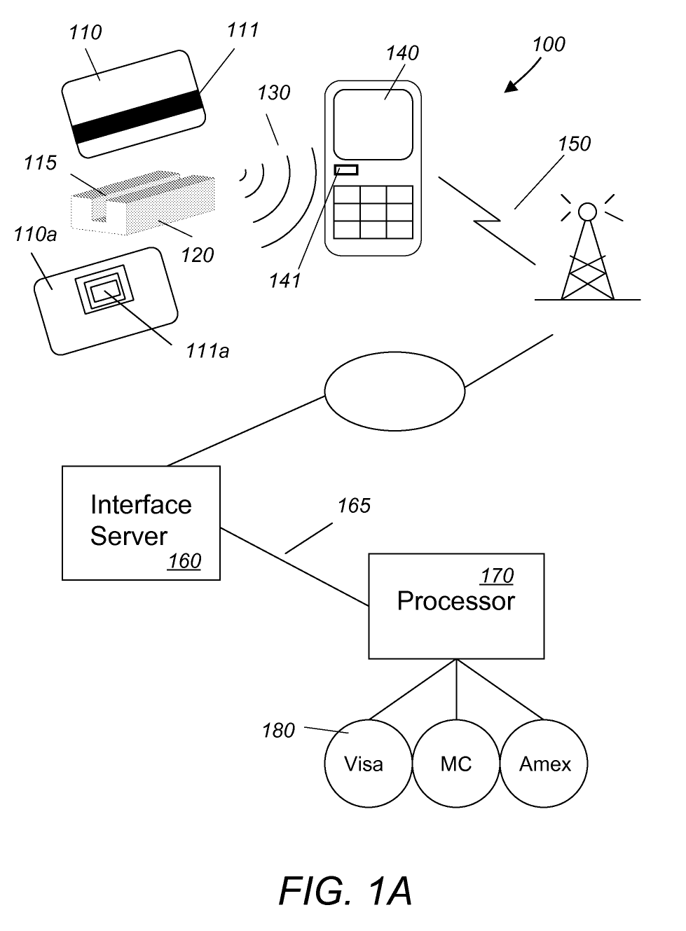

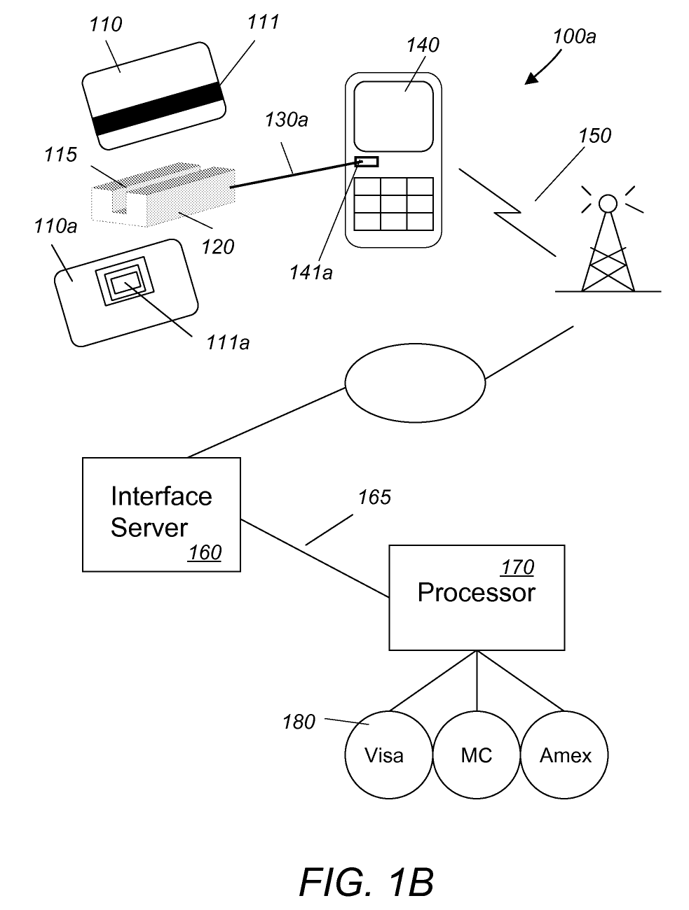

Referring to FIG. 1A, an acoustically coupled card reader system 100 includes an acoustically coupled card reader 120, a cell phone 140 receiving acoustical signals 130 from the reader 120 via the microphone 141, an interface server 160 receiving data from the cellphone 140 via a network connection 150 and a payment card processor 170 for processing payments via payment-card companies 180.

Referring to FIG. 1B, an audio coupled card reader system 100a includes an audio coupled card reader 120a, a cell phone 140 receiving audio signals 130a from the reader 120a via the microphone jack 141a, an interface server 160 receiving data from the cellphone 140 via a network connection 150 and a payment card processor 170 for processing payments via payment-card companies 180.

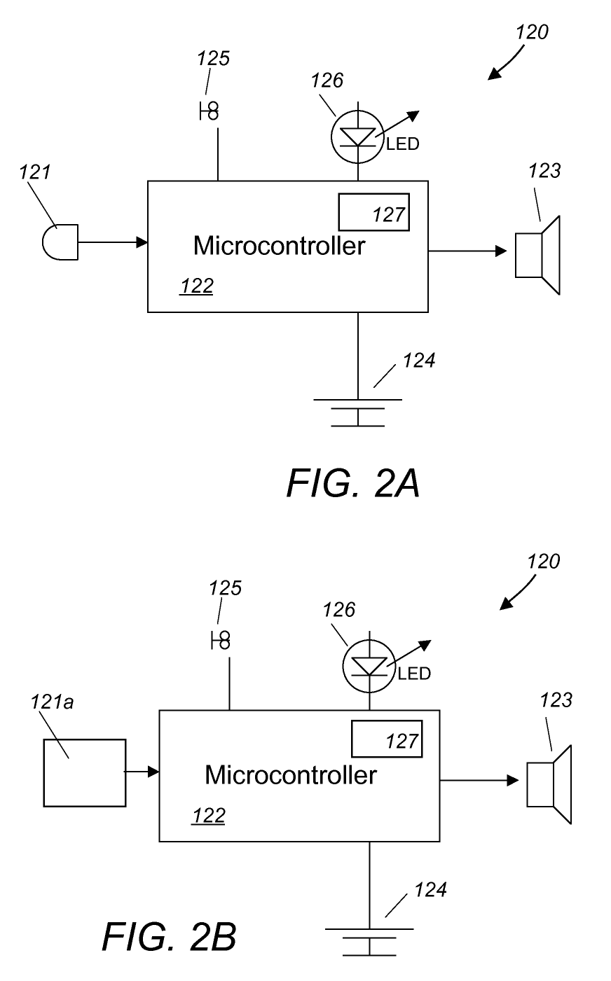

Referring to FIG. 2A, the audio/acoustically coupled card reader 120 includes a card reader magnetic head 121, a microcontroller 122, a speaker 123, a battery 124, a push button 125 and an indicator light 126. Magnetic head 121 reads data stored in the magnetic stripe 111 of a magnetic stripe card 110, shown in FIG. 1. Referring to FIG. 2B, in another embodiment, the audio/acoustically coupled card reader 120 includes electrical contact means or electromagnetic near-field means 121 a for reading data stored in a smart card circuit 111a of contact or contactless smart card 110a, respectively, shown in FIG. 1. This card reader 120 also includes a microcontroller 122, a speaker 123, a battery 124, a push button 125 and an indicator light 126. In other embodiments, card reader 120 includes both a magnetic head 121 and electrical contact means and/or electromagnetic near-field means 121a for reading magnetic cards, contact and/or contactless smart cards, respectively.

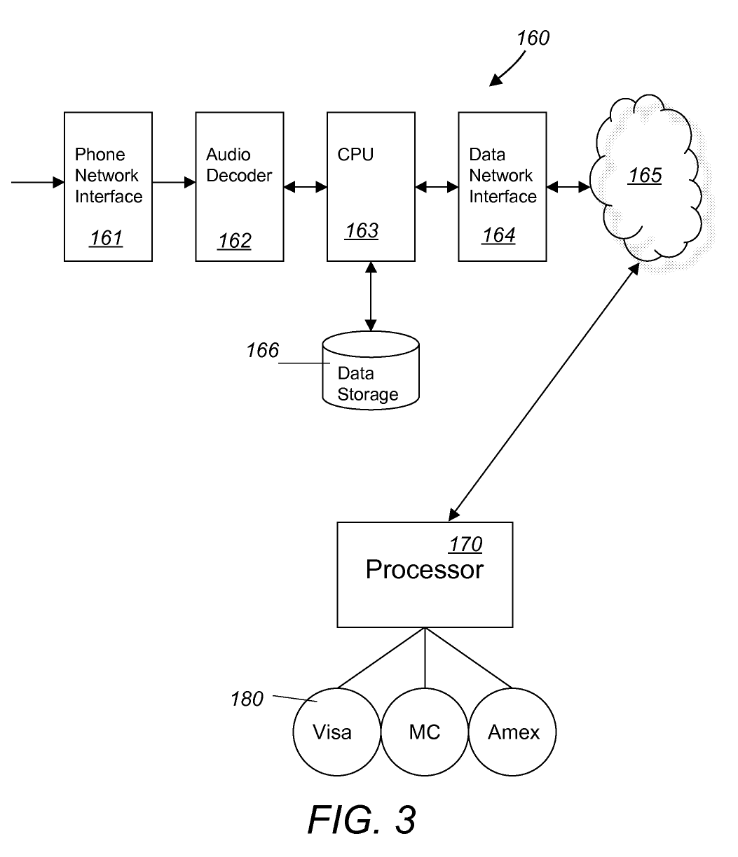

Referring to FIG. 3, the interface server 160 includes a phone network interface 161, an audio decoder 162, a central processing unit (CPU) 163, a data network interface 164, and data storage 166. Interface server 160 receives data from cellphone 140 via a phone network 150 and transmits data to a processor 170 via data network 165. In one example, data network 165 is the Internet.

The audio/acoustically coupled card reader 120 reads a magnetic stripe card 110 by swiping the card through the card reader slot 115. The card reader 120 senses the magnetic encoding on the card's magnetic stripe 111 and checks the card data for errors. In other embodiments, credit card 110 is a “smart card”, i.e., it includes an electronic circuit that stores the card data. In this case, the card reader 120 reads the information stored in the smart card circuit either contactlessly via a near-field coupling or via electrical contacts. If the card read is error free, which is indicated by a light 126, the reader 120 stores the card data until the user is ready to transfer it to the phone, which is initiated when the user presses the “Send” button 125 on the reader, as shown in FIG. 2A. To transmit the card data to the phone or cellphone the reader 120 generates an appropriately encoded stream of sound signals 130 that are picked up by the microphone 141 of the phone or cellphone. In the case of an audio coupled reader 120a, the reader 120a generates an appropriately encoded stream of audio signals 130a, which are then sent to the microphone jack 141a of the phone or cellphone. Other transaction data are entered through the phone's keypad. The phone then transmits the electrical information representing the audio/acoustically received card data via a previously established connection 150 to an interface server 160. Other transaction data that were entered via the phone's keypad or touch screen are transmitted as digital data. At the interface server 160 an audio decoder 162 receives and processes the electrical signals (which can be analog or digital) to extract the original card data. Audio decoder 162 is implemented either as a suitable software program or as hardware. The extracted data are then combined with the other transaction data to create a “regular” card swipe transaction for transmission to processor 170 for approval and processing. This method allows the transaction to be a card-read transaction, with all the security and cost benefits of a card-read transaction, just as if it originated from a point of sale transaction terminal. Various methods are used to ensure that the transmission of the card data both across the acoustic interface and the electronic transmission link is secure and error-free. In other embodiments, a software implementation of the interface server 160 is incorporated in the cellphone 140. The cellphone 140 extracts the payment card data via a software audio decoder 162 and then transmits the data to processor 170.

As was mentioned above, the card reader 120 is also designed to read both contact and contactless smart cards 110a. These smart cards readers use electrical contacts or electromagnetic near-field means 121a (shown in FIG. 2B) for reading the data stored in the smart card circuit 111a for the contact or contactless smart card, respectively. The same acoustic transmission method is used to convey the smart card data to the phone as used for magnetic stripe cards.

Several embodiments of the present invention have been described. Nevertheless, it will be understood that various modifications may be made without departing from the spirit and scope of the invention. Accordingly, other embodiments are within the scope of the following claims.

What is claimed is:

1. A system for performing mobile payment transactions comprising:
an audio/acoustically coupled card reader comprising means for reading payment card data from a payment card, means for generating a stream of audio/acoustical signals comprising said payment card data and means for transmitting said stream of audio/acoustical signals;
a mobile communication device comprising means for receiving said stream of audio/acoustical signals, means for generating an electrical signal comprising data contained in said stream of audio/acoustical signals and means for transmitting said electrical signal;
an interface server, wherein said mobile communication device connects to said interface server device via a first network and transmits said electrical signal to said interface server and wherein said interface server comprises means for extracting said payment card data from said electrical signal and means for transmitting said payment card data; and
a payment card processor for processing payments via payment card companies, wherein said interface server connects to said payment card processor via a second network and transmits said payment card data to said payment card processor for payment processing.

2. The system of claim 1 wherein said second network comprises one of the Internet, a wireless local area network (WLAN), a personal area network (PAN) or a private communication network.

3. The system of claim 1 wherein said first network comprises one of a telecommunication network or a mobile telecommunication network comprising one of a Global System for Mobile Communications (GSM), a Code Division Multiple Access (CDMA), CDMA 2000, wideband CDMA (WCDMA), or 3G.

4. The system of claim 1 wherein said payment card comprises a magnetic stripe for storing said payment card data and wherein said means for reading said payment card data comprises a magnetic head.

5. The system of claim 1 wherein said payment card comprises a contact-type smart card and said contact-type smart card comprises an electronic circuit for storing said payment card data and wherein said means for reading said payment card data comprises electrical contact means.

6. The system of claim 1 wherein said payment card comprises a contactless smart card and said contactless smart card comprises an electronic circuit for storing said payment card data and wherein said means for reading said payment card data comprises contactless near-field electromagnetic means.

7. The system of claim 1 wherein said audio/acoustically coupled card reader further comprises means for checking for an error in said payment card data and means for indicating absence of an error in said payment card data.

8. The system of claim 1 wherein said audio/acoustically coupled card reader further comprises means for storing said payment card data and means for activating transmission of said stream of audio/acoustical signals.

9. The system of claim 1 wherein said mobile communication device further comprises a keypad for entering other transaction data.

10. The system of claim 1 wherein said means for extracting said payment card data from said electrical signal comprises an audio decoder and wherein said interface server further comprises a first network interface, a central processing unit, a second network interface and a data storage.

11. The system of claim 1 wherein said mobile communication device comprises said interface server.

12. A method for performing mobile payment transactions comprising:
providing an audio/acoustically coupled card reader comprising means for reading payment card data from a payment card, means for generating a stream of audio/acoustical signals comprising said payment card data and means for transmitting said stream of audio/acoustical signals;
reading payment card data from a payment card via said card reader reading means, generating a stream of audio/acoustical signals comprising said payment card data via said card reader generation means and transmitting said stream of audio/acoustical signals via said card reader transmission means;
providing a mobile communication device comprising means for receiving said stream of audio/acoustical signals, means for generating an electrical signal comprising data contained in said stream of audio/acoustical signals and means for transmitting said electrical signal;
receiving said stream of audio/acoustical signals by said mobile communication device's receiving means, generating an electrical signal comprising said payment card data contained in said stream of audio/acoustical signals by said generation means of said mobile communication device and transmitting said electrical signal by said mobile communication device's transmission means;
providing an interface server comprising means for extracting said payment card data from said electrical signal and means for transmitting said payment card data;
connecting said mobile communication device to said interface server device via a first network and transmitting said electrical signal to said interface server by said mobile communication device's transmission means;
providing a payment card processor for processing payments via payment card companies;
connecting said interface server to said payment card processor via a second network;
transmitting said payment card data to said payment card processor by said interface server's transmission means; and
processing said payment card data by said payment card processor.

13. The method of claim 12 wherein said second network comprises one of the Internet, a wireless local area network (WLAN), a personal area network (PAN) or a private communication network.

14. The method of claim 12 wherein said first network comprises one of a telecommunication network or a mobile telecommunication network comprising one of a Global System for Mobile Communications (GSM), a Code Division Multiple Access (CDMA), CDMA 2000, wideband CDMA (WCDMA), or 3G.

15. The method of claim 12 wherein said payment card comprises a magnetic stripe for storing said payment card data and wherein said means for reading said payment card data comprises a magnetic head.

16. The method of claim 12 wherein said payment card comprises a contact-type smart card and said contact-type smart card comprises an electronic circuit for storing said payment card data and wherein said means for reading said payment card data comprises electrical contact means.

17. The method of claim 12 wherein said payment card comprises a contactless smart card and said contactless smart card comprises an electronic circuit for storing said payment card data and wherein said means for reading said payment card data comprises contactless near-field electromagnetic means.

18. The method of claim 12 wherein said audio/acoustically coupled card reader further comprises means for checking for an error in said payment card data and means for indicating absence of an error in said payment card data.

19. The method of claim 12 further comprising storing said payment card data in said audio/acoustically coupled card reader and activating transmission of said stream of audio/acoustical signals comprising said payment card data.

20. The method of claim 12 wherein said mobile communication device further comprises a keypad for entering other transaction data.

21. The method of claim 12 wherein said means for extracting said payment card data from said electrical signal comprises an audio decoder and wherein said interface server further comprises a first network interface, a central processing unit, a second network interface and a data storage.

22. The method of claim 12 wherein said mobile communication device comprises said interface server.
